(19) United States
(12) Patent Application Publication
(10) Pub. No.: US 2001/0036009 A1
(43) Pub. Date: Nov. 1, 2001

(54) Surface-emitting semiconductor optical amplifier

(76) Inventors: Xun Li, Waterloo (CA); Wei-Ping Huang, Ancaster (CA)

Correspondence Address: STROOCK & STROOCK & LAVAN, LLP., 180 Maiden Lane, New York, NY, 10038, US

(21) Appl. No.: 09/789,371

(22) Filed: Feb. 20, 2001

Related U.S. Application Data
(60) Provisional application No. 60/183,317, filed on Feb. 17, 2000.

(51) Int. Cl. H01S 3/00

(52) U.S. Cl. 359/344

(57) ABSTRACT

A surface-emitting optical amplifier having a generally circular waveguide and active region. The waveguide and active region match the shape of an optical fiber or other device for generating, transmitting, guiding, propagating, etc., an optical signal. For example, the shape of the waveguide and active region may be circular, elliptical, square, rectangular, or virtually any other required shape. By matching the shape of the waveguide and active region to the shape of the device to which the waveguide connects, coupling loss is reduced and polarization dependent loss is eliminated due to the symmetry of the active region. The reduction of the coupling loss also leads to an increase of the signal to noise ratio since the signal loss from the input coupling is directly reduced.

### CROSS-REFERENCE TO RELATED APPLICATION

This application claims priority to Provisional Patent Application Serial No. 60/183,317, filed on Feb. 17, 2000.

### FIELD OF THE INVENTION

The present invention is directed to a surface-emitting optical amplifier.

### BACKGROUND OF THE INVENTION

Optical amplifiers are an essential part of optical communication networks (data or voice). The great distances an optical signal (also referred to herein as a light signal) is transmitted require that the signal be periodically amplified. Unfortunately, interconnection between optical amplifiers and other optical transmission devices (e.g., fiber-optic cables, passive optical devices, etc.) introduce undesirable losses and may also otherwise adversely affect the integrity of the optical signal. For example, optical amplifiers typically include a waveguide with an active region within which the optical signal is amplified. While various shapes for the active region are known, none match the shape of a fiber-optic cable, i.e., none of the known active region shapes are circular. Known, non-circular active regions produce coupling loss, which leads to a reduction in the signal-to-noise ratio. In addition, known non-circular active regions are polarization dependent, i.e., a waveguide (and active region) can typically only amplify and guide one of the polarization modes (transverse electric or transverse magnetic) of an optical signal.

It is thus desirable to provide an optical amplifier that overcomes the above-described shortcomings of the prior art.

### SUMMARY OF THE INVENTION

The present invention is directed to a surface-emitting optical amplifier having a generally circular waveguide and active region. Light enters and exits the amplifier of the present invention generally in the same direction as the layer growth direction. Consequently, the shape of the waveguide and active region can be controlled because they are formed by photolithography, which is a mature fabrication technology.

The waveguide and active region match the shape of an optical fiber or other device for generating, transmitting, guiding, propagating, etc., an optical signal. For example, the shape of the waveguide and active region may be circular, elliptical, square, rectangular, or virtually any other required shape. By matching the shape of the waveguide and active region to the shape of the device to which the waveguide connects, coupling loss is reduced and polarization dependent loss is eliminated due to the symmetry of the active region. The reduction of the coupling loss also leads to an increase of the signal to noise ratio since the signal loss from the input coupling is directly reduced.

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference characters denote similar elements throughout the several views:

FIG. 1 is a top view of a surface emitting semiconductor optical amplifier having two generally circular waveguides and constructed in accordance with the present invention;

FIG. 2 is a cross-sectional side view of a transmission mode surface emitting semiconductor optical amplifier having anti-reflective coating on both input and output facets and taken along the line A-A of FIG. 1;

FIG. 3 is a cross-sectional side view of a reflection mode surface emitting semiconductor optical amplifier having anti-reflective coating on an input facet and high-reflective coating on a surface opposite the input surface and taken along the line B-B of FIG. 1;

FIG. 4 is a diagrammatic side view of a packaged reflection mode surface emitting semiconductor optical amplifier;

FIG. 5 is a diagrammatic side view of a packaged transmission mode surface emitting semiconductor optical amplifier;

FIG. 6 is a top diagrammatic view of an optical switch having a plurality of passive optical devices optically coupled to a reflection mode surface emitting semiconductor optical amplifier constructed in accordance with the present invention;

FIG. 7 is a top diagrammatic view of an optical switch having an optical splitter optically coupled to a transmission mode surface emitting semiconductor optical amplifier constructed in accordance with the present invention;

FIG. 8 is a schematic view of a 1×N optical switch constructed of a plurality of 1×2 optical switches constructed in accordance with the present invention;

FIG. 9 is a schematic view of a 2×2 optical switch constructed of a plurality of 1×2 optical switches constructed in accordance with the present invention;

FIG. 10 is a schematic view of a 2×2 optical switch constructed of two 1×2 optical switches constructed in accordance with the present invention;

FIG. 11 is a schematic view of a 2×2 optical switch matrix constructed of four 1×2 optical switches constructed in accordance with the present invention; and

FIG. 12 is a cross-sectional view of a multiple quantum well active region.

### DETAILED DESCRIPTION OF THE PRESENTLY PREFERRED EMBODIMENTS

The present invention is directed to a surface-emitting optical amplifier having a generally circular waveguide and active region. The waveguide and active region match the shape of an optical fiber or other device for generating, transmitting, guiding, propagating, etc., an optical signal. For example, the shape of the waveguide and active region may be circular, elliptical, square, rectangular, or virtually any other required shape. By matching the shape of the waveguide and active region to the shape of the device to which the waveguide connects, coupling loss is reduced and polarization dependent loss is eliminated due to the symmetry of the active region. The reduction of the coupling loss also leads to an increase of the signal to noise ratio since the signal loss from the input coupling is directly reduced.

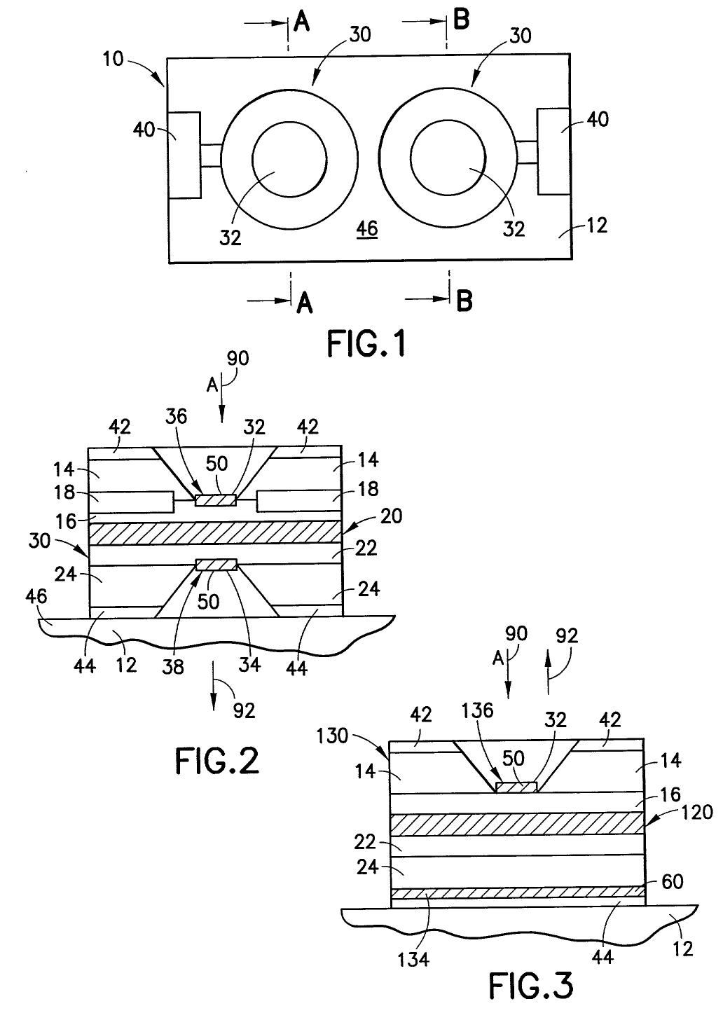

Referring now to the drawings in detail, FIG. 1 is a top view of a surface-emitting semiconductor optical amplifier 10 constructed in accordance with the present invention. The amplifier 10 is preferably fabricated of group III and group V semiconductors such as, for example, InP or InGaAsP, on a semiconductor substrate 12 having a top surface 46. The amplifier 10 includes a generally circular waveguide 30 having a first surface 32 through which light (an optical signal) enters the waveguide 30, and a second surface 34, via which light exits the waveguide 30, in certain embodiments (see, e.g., FIG. 2 and the discussion thereof below). Amplifier 10 includes a second waveguide 130 (see, e.g. FIG. 3) having a first surface 132 through which light enters waveguide 130 and a second surface 134, via which light exists waveguide 130. An electrode 40 connects to the waveguide 30 and provides an electrical path via which an electrical signal or field (i.e., current) may be introduced into the active region 20 (see, e.g., FIGS. 2 and 3). The optical characteristics of the waveguide 30 (and active region 20) may be changed by the introduction of an electrical signal or field due to the opto-electric effect. Thus, wavelength selectivity of a waveguide 30 (and of the amplifier 10) may be selectively controlled.

The waveguide 30 is preferably circular (top view), but may be any shape manufacturable using now known or hereafter developed semiconductor fabrication processes. The preferred shape of the waveguide 30 may depend, at least on part, on the shape of the optical device connected to the waveguide 30. For example, if an optical amplifier 10 is constructed having a waveguide 30 in accordance with the present invention, and intended to connect to a fiber-optic cable, the desired shape of the waveguide 30 is generally circular, matching the shape of the fiber-optic cable. And although the desired shape of a fiber-optic cable (or other long-haul optical transmission device) may be circular, the present invention provides an optical amplifier having a waveguide and active region whose shape may be selectively shaped to match that of the optical device to which it connects.

Two embodiments of a surface-emitting optical amplifier constructed in accordance with the present invention are depicted in FIGS. 2 and 3 and will now be discussed in detail. Referring first to FIG. 2, a cross-sectional view of a waveguide 30 of a transmission mode (i.e., single-pass), surface-emitting optical amplifier 10 is depicted. The waveguide 30 and the various layers may be fabricated using any now known or hereafter developed semiconductor fabrication techniques and methods, e.g., photolithography.

A metal-alloy electrode 40 comprises both p-type (top electrode) 42 and n-type (bottom electrode) 44 parts. The p-type electrode 42 is preferably an alloy consisting of Ti, Pt, and Au; while the n-type electrode 44 is preferably an alloy consisting of Au, Ge, and Ni. An electrical signal or field (i.e., current) may be injected into the active region 20 via the electrode 40 to generate optical gain within the amplifier 10.

The active region 20 may be either a bulk or a multiple quantum well (MQW) active region, as a routine matter of design choice. A bulk active region 20 is preferably InGaAsP and approximately 1 μm thick (i.e., in the vertical direction in the figures). A MQW active region 20, depicted in FIG. 12, is preferably constructed of three tensile strained (TS) and three compressive strained (CS) quantum well layers 80, 82, each layer having a thickness of approximately 1.55 μm (which represents the gain-peak wavelength in the active region 20). The active region material (e.g., InGaAsP) is preferably chosen so that its gain-peak is located approximately at 1.55 μm. The TS and CS quantum well layers 80, 82 are InGaAsP, for example, or other suitable semiconductor materials. Five barrier layers 84 of InGaAsP are provided between each TS layer 80 and each CS layer 82, each barrier layer 84 having a thickness of approximately 100 Å.

Upper and lower anti-reflection cladding layers 16, 22 are, respectively, p-doped InP and n-doped InP, each having a doping concentration of approximately 5×10¹⁷/cm³ and each being approximately 1 μm thick. A carrier block layer 18 is disposed above the upper cladding layer 16 and is preferably n-doped InP having a doping concentration of approximately 5×10¹⁷/cm³ and being approximately 1 μm thick. Above the carrier block layer 18 is disposed a buffer layer 14 of p-doped Inp having a doping concentration of approximately 1×10¹⁸/cm³ and being approximately 2.5 μm thick.

Below the lower cladding layer 22 is disposed a buffer layer 24 of n-doped Inp having a doping concentration of approximately 1×10¹⁸/cm³ and being approximately 70 μm thick. The electrode 40 is disposed above and below the buffer layers 14 and 24, respectively.

A first surface 32 having an anti-reflective coating 50 defines an input facet 36 through which light may enter the waveguide 30. A second surface 34, generally parallel with the first surface 32, also has an anti-reflective coating 50 and defines an output facet 38 via which light emerges (amplified) from the waveguide 30. In a preferred embodiment, the input and output facets 36, 38 are generally circular, and preferably match the shape of the device connected to the waveguide 30 and from which an optical signal is input to the waveguide 30 and to which an optical signal is output from the waveguide 30.

In operation, an optical signal 90 from an optical source (not shown) and defining an optical signal path, indicated by arrow A, is input to the waveguide 30 through the input facet 36 and is guided by the waveguide 30 into the active region 20. Amplification of the optical signal occurs in the active region 20, and the amplified optical signal passes from the active region 20 and is output as an amplified optical signal 92 from the waveguide 30 via the output facet 38 to a fiber-optic cable, for example (see, e.g., FIG. 5). The optical amplifier 10 of the present invention is fabricated using known (or hereafter developed) semiconductor fabrication techniques and methods (e.g., epitaxial growth, photolithography, etching, etc.). Layers of semiconductor material are selectively deposited and removed, forming a plurality of layers having predetermined semiconductor material composition and doping levels (where appropriate). The plurality of layers are arranged with respect to each other to form a plurality of generally parallel layers (or at least, each layer defines a surface that is generally parallel with a surface of each of the other layers). In an advantageous and non-obvious manner, the present invention provides an optical amplifier which defines an optical path that is generally perpendicular to the surface(s) defined by the plurality of semiconductor layers. The shape of the optical amplifier, its input and output facets, and the active region may thus be constructed to match the shape of the optical device being connected to the amplifier (e.g., a fiber-optic cable). In contrast, prior art optical amplifiers define an optical path that is generally parallel with the surface(s) of the semiconductor layers. That configuration precludes matching the shape of prior art optical amplifiers to the shape of the optical device connected thereto.

In the present invention, coupling loss is minimized between the optical source and waveguide 30 due to the match of their respective shapes. Moreover, polarization dependence of the waveguide 30 is eliminated due to the symmetrical shape of the waveguide 30 and active region 20. Finally, the signal-to-noise ratio is effectively increased due to the reduction in signal loss attributable to the reduced coupling loss.

Referring next to FIG. 3, a cross-sectional view of a waveguide 130 of a reflection mode (i.e., dual-pass), surface-emitting optical amplifier 10 is depicted. The construction of the reflection mode amplifier 10 of FIG. 3 is substantially the same as that of the transmission mode amplifier 10 of FIG. 2. However, a high reflective coating 60 is provided on the second surface 134 and the n-doped buffer 24 is approximately 100 μm thick.

In operation, an optical signal from an optical source (not shown) is input to the waveguide 130 through the input facet 136 and is guided by the waveguide 130 into the active region 120. Amplification of the optical signal occurs in the active region 120, and the amplified optical signal passes from the active region 120 toward the second surface 134. The now-amplified optical signal is reflected by the high reflective coating 60 and directed back towards and through the active region 120, and exits the waveguide via the input facet 136.

The advantageous optical effects provided by the embodiments of the present invention are a consequence of the effective matching of the shapes of the output of an optical transmission device (e.g., fiber-optic cable, waveguide, optical transmitter, etc.) and an input of optical amplifier 10.

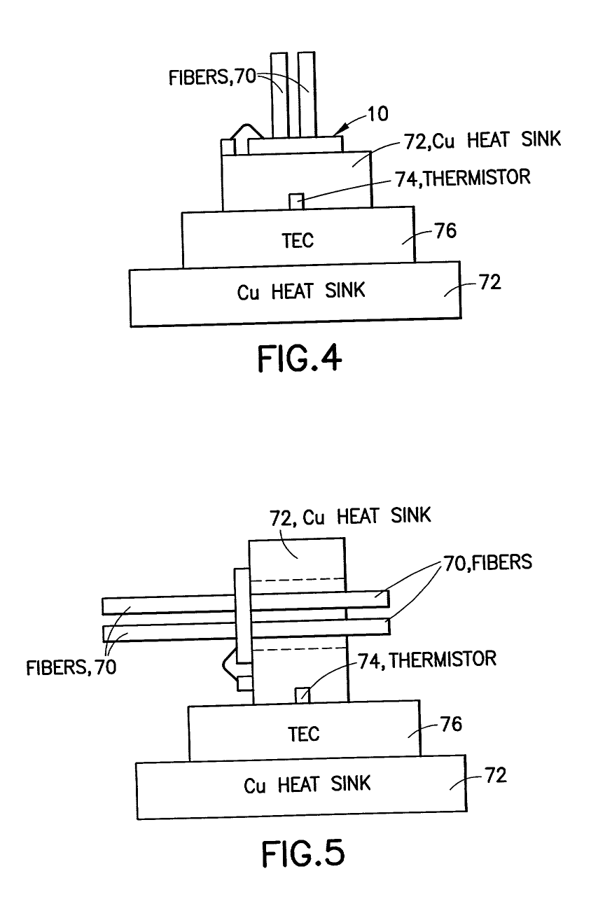

The optical amplifier 10 of the present invention may be assembled with other optical and non-optical devices to provide a variety of types of optical amplifiers. For example, and with reference to FIGS. 4 and 5, exemplary packaging of a reflection mode and transmission mode optical amplifier 10 in accordance with the present invention are respectively depicted. In FIG. 4, two fiber-optic cables (fibers) 70 are connected to a reflection mode optical amplifier 10. A plurality of heat sinks 72, a thermistor 74, and a thermal electronic cooler 76, provide cooling control for the amplifier 10. Similarly, and as depicted in FIG. 5, cooling control for a transmission mode optical amplifier 10 is provided by a plurality of heat sinks 72, a thermistor 74, and a thermal electronic cooler 76. Two sets of fiber-optic cables 70 are provided for both input and output optical signals.

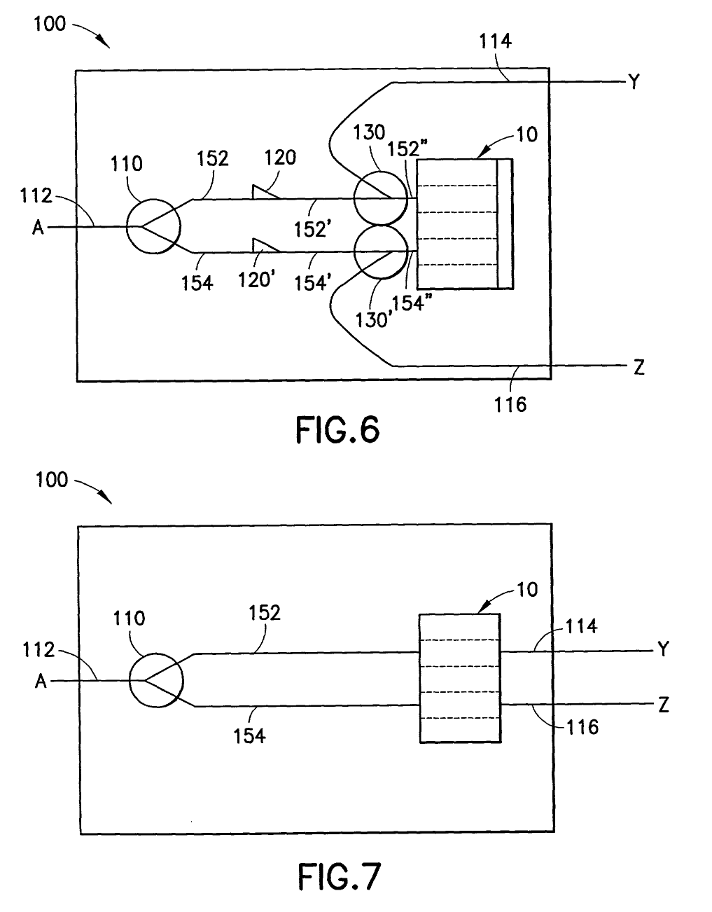

Using an optical amplifier constructed in accordance with the embodiments of the present invention, various optical switches and switching devices may be constructed. For example, and with reference next to FIGS. 6-11, illustrative, non-limiting examples of such switches and switching devices are depicted and will now be discussed.

In FIG. 6, an embodiment of an optical switch 100 having a reflection mode optical amplifier 10 constructed in accordance with the present invention is there depicted. An input of the switch 110 is designated by reference letter A and comprises an input waveguide 112 which may receive a light signal from an optical source (not shown) via a fiber-optic cable (not shown) connected to the switch 10 using known techniques and devices. The switch 100 includes a plurality of passive optical components, designated by reference numerals 110, 120, 130. A −3 dB optical power splitter 110 is optically coupled to the input waveguide 112 for receiving a light signal propagating therethrough. The output waveguides 152, 154 of the splitter 110 provide an optical path between the splitter 110 and two optical isolators 120, 120′ and guide a light signal from the splitter outputs to each isolator 120, 120′. The isolators 120, 120′ each prevent reverse propagation of a light signal, i.e., into the outputs of the splitter 110. Waveguides 152′, 154′ from the isolators 120, 120′ provide an optical path between the optical isolators 120, 120′ and two optical circulators 130, 130′. Light passes through the circulators 130, 130′ when propagating from left to right (in the drawings) and is guided by waveguides 152″, 154″ into two waveguides 30 of the amplifier 10 through the anti-reflective coating 50 of the input facet 36 (see, e.g., FIG. 2), is amplified by the active region 20, reflected by the high reflectivity coating 60 back through the gain region 20, and exits the amplifier 10 via the input facet 36. The amplified optical signal re-enters the circulators 130, 130′ propagating in a direction from right to left (in the drawings). Light does not re-enter waveguide 152′ or 154′. Instead, the circulators 130, 130′ redirect the light signal to an output of the switch 100, generally designated by reference letters Y and Z, via a respective output waveguide 114, 116.

Referring next to FIG. 7, an optical switch 100 having a transmission mode optical amplifier 10 constructed in accordance with an embodiment of the present invention is depicted. An input of the switch 100 is designated by reference letter A and comprises an input waveguide 112 which may receive a light signal from an optical source (not shown) via a fiber-optic cable (not shown) connected to the switch 100 using known techniques and devices. The input waveguide 112 provides an optical path and guides the light signal to a passive optical component 110, depicted as a −3 dB optical power splitter in FIG. 7 having two outputs. An optical signal input to the splitter 110 is divided equally (in terms of optical power) between the two outputs, which are provided in the form of waveguides 152, 154 that provide an optical path between the splitter 110 and two waveguides 30 of the optical amplifier 10. Two waveguides 114, 116 provide optical path outputs for light signals from the amplifier 10 and also provide two outputs of the switch 100, generally designated by reference letters Y and Z. Alternatively, two fiber-optic cables (see, e.g., FIG. 5) may be optically connected to the amplifier 10 to provide an output optical signal from the switch 100. In operation, an optical signal is guided by waveguide 112 into splitter 110 and output from splitter 110 on waveguides 152, 154 and guided thereby into amplifier 10. Each waveguide 30 of amplifier 10 amplifies the optical signal by approximately 3 dB. Both the input facet 36 and output facet 38 are coated with an anti-reflective coating 50. The light signal may be selectively output from the amplifier 10 on either output Y or output Z via waveguide 114 or 116.

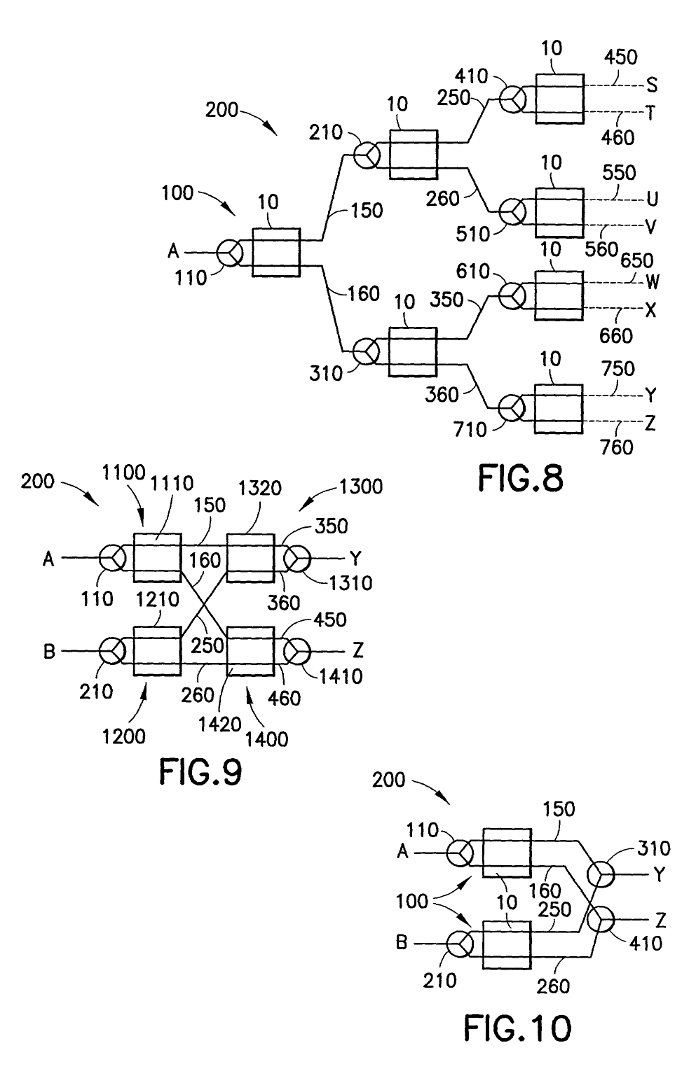

A variety of optical switches and switch matrices may be constructed in accordance with the present invention. For example, FIGS. 8-11 depict illustrative, non-limiting embodiments of such switches and switch matrices. Referring first to FIG. 8, a 1×N optical switch 200 comprises a plurality of optical switches 100, each constructed in accordance with the present invention and each comprising a −3 dB passive optical splitter 110, 210, 310, 410, 510, 610, 710, and a two channel (i.e., two waveguide 30 or 30, 130 or 130, 130), transmission mode optical amplifier 10 constructed in accordance with the present invention. An optical signal provided at the input A propagates through the optical switch 200 without being amplified due to the offsetting −3 dB loss introduced by the splitters 110 and 3 dB gain provided by the amplifiers 10. A single input A may be selectively switched between any of a plurality of outputs S-Z and output from the switch 200 via respective output waveguide 450, 460, 550, 560, 650, 660, 750, 760. By applying an electrical signal or electrical field to the electrode 40, the wavelength selectively of each amplifier 10 may be controlled due, at least in part, to the electro-optic effect. Thus, each amplifier 10 of the switch 200 may be tuned so that a desired wavelength is output from a selective output and thus propagates through the switch 200 over a predetermined path and is output from the switch 200 via a selected one of the N outputs.

Referring next to FIG. 9, a 2×2 optical switch 200 comprises four transmission mode optical switches 1100, 1200, 1300, 1400. Switches 1100 and 1200 each include a −3 dB passive optical splitter 110, 210 optically coupled to a two channel optical amplifier 1110, 1210. Switches 1300 and 1400 each include a −3 dB passive combiner 1310, 1410 optically coupled to a two channel, single-pass 3 dB gain optical amplifier 1320, 1420. A first optical switch 1100 receives an optical signal on input A (while input A is discussed below, the following applies to an optical signal on input B) which is attenuated by a first passive splitter 110 and amplified by a first amplifier 1100. The output of the first amplifier 1100 is optically connected via waveguide 150 to the input of a second amplifier 1300, which further amplifies the optical signal. The output of the second amplifier 1300 is attenuated (approximately back to the power level of the optical signal input at input A) by a combiner 1310 and output from the switch 200 on output Y. That same optical signal present on input A may alternatively be output from the switch 200 on output Z by being output from amplifier 1100 via waveguide 160 and through amplifier 1400, a waveguide 450 and combiner 1410. Similarly, an input B can be output at either output Y or Z.

An alternative embodiment of a 2×2 switch 200 in accordance with the present invention is depicted in FIG. 10. The optical amplifier 10 of that embodiment is preferably a two channel, transmission mode amplifier 10. The configuration of FIG. 10 (and also that of FIG. 9) are scaleable to provide a N×N switch 20, i.e., the number of inputs and outputs may be selected as a routine matter of design choice, and configured in accordance with the present invention and as depicted in FIG. 10 for a 2×2 switch.

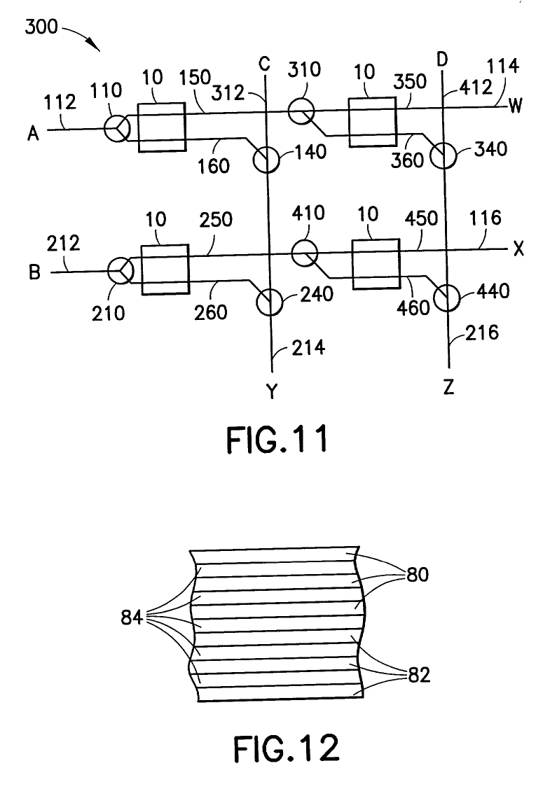

Referring next to FIG. 11, the optical amplifier 10 of the present invention may be used to construct a 2×2 switch matrix 300 having four inputs A-D and four outputs W-Z. An optical signal may be provided at any of inputs A-D, and that optical signal may be selectively routed to one of a plurality of outputs W-Z. For example, an optical signal present at input A or input B may be selectively routed to any of outputs W-Z. Similarly, an optical signal present at input C or input D may be output from outputs Y and Z, respectively. In the embodiment depicted in FIG. 11, any of the switches 10 may be selectively tuned to redirect an optical signal having a predetermined wavelength present at either input A or input B to any of the four outputs W-Z. For example, when a light signal is present at input A, switch 10 may be tuned so that that light signal is output from any of outputs W-Z. For an output from W, the light signal may be output from amplifier 10 via waveguide 160 and combine in optical combiner 140 (which is actually an optical splitter connected in reverse) with a light signal present at input C via waveguide 312. The output of combiner 140 may combine with another optical signal in combiner 240, if an optical signal is output from switch 10 via waveguide 260.

It will be obvious to persons skilled in the art and from the disclosure provided herein that any of the amplifier 10 embodiments disclosed herein may be used to construct the switches and switch fabrics depicted n FIGS. 8-11. It will be further obvious that the various embodiments discussed herein are provided as illustrative, non-limiting examples of the present invention, and that variations in materials, fabrication methods and techniques, and construction of optical devices, are contemplated by and within the scope of the present invention.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A semiconductor optical amplifier comprising a circular waveguide having a first surface defining a circular input facet through which an optical signal may enter said waveguide, and a second surface generally parallel with said first surface, said waveguide having a circular active region disposed between said first and said second surface.

2. A semiconductor optical amplifier as recited in claim 1, further comprising an anti-reflective coating on said first surface.

3. A semiconductor optical amplifier as recited in claim 2, further comprising an anti-reflective coating on said second surface, and wherein said second surface defines a circular output facet through which the optical signal may exit said waveguide.

4. A semiconductor optical amplifier as recited in claim 2, further comprising a high reflective coating on said second surface, and wherein said first surface further defines a circular output facet through which the optical signal may exit said waveguide.

5. A semiconductor optical amplifier as recited in claim 1, wherein said waveguide is constructed on a substrate, and wherein said waveguide and said substrate are constructed from group III and group V semiconductors.

6. A semiconductor optical amplifier as recited in claim 1, further comprising a second circular waveguide having a first surface defining a circular input facet through which the optical signal may enter said second waveguide, and a second surface generally parallel with said first surface, said second waveguide having a circular active region between said first and said second surface.

7. A semiconductor optical amplifier as recited in claim 6, further comprising an anti-reflective coating on said first surface of said second waveguide.

8. A semiconductor optical amplifier as recited in claim 7, further comprising an anti-reflective coating on said second surface of said waveguide, and wherein said second surface defines a circular output facet through which the optical signal may exit said second waveguide.

9. A semiconductor optical amplifier as recited in claim 7, further comprising a high reflective coating on said second surface of said waveguide, and wherein said first surface further defines a circular output facet through which the optical signal may exit said second waveguide.

10. A semiconductor optical amplifier as recited in claim 6, wherein said waveguide and said second waveguide are constructed on a substrate, and wherein said waveguide, said second waveguide, and said substrate are constructed from group III and group V semiconductors.

11. An optical amplifier comprising:
a substrate having a surface; and
a waveguide disposed on said substrate surface and having a first surface generally parallel with said substrate surface and defining an input facet through which an optical signal from an optical source may enter said waveguide, and a second surface generally parallel with said first surface, said waveguide having an active region disposed between said first and said second surfaces, the optical signal defining an optical signal path through said waveguide that is generally perpendicular to said waveguide first surface and input facet.

12. An optical amplifier as recited in claim 11, further comprising an anti-reflective coating on said first surface.

13. An optical amplifier as recited in claim 12, further comprising an anti-reflective coating on said second surface, and wherein said second surface defines an output facet through which the optical signal may exit said waveguide.

14. An optical amplifier as recited in claim 12, further comprising a high reflective coating on said second surface, and wherein said first surface further defines an output facet through which the optical signal may exit said waveguide.

15. An optical amplifier as recited in claim 11, wherein waveguide and said substrate are constructed from group III and group V semiconductors.

16. An optical amplifier as recited in claim 11, further comprising a second a waveguide disposed on said substrate surface and having a first surface generally parallel with said substrate surface and defining an input facet through which an optical signal from an optical source may enter said waveguide, and a second surface generally parallel with said first surface, said waveguide having an active region between said first and said second surfaces, the optical signal defining an optical signal path through said waveguide that is generally perpendicular to said waveguide first surface and input facet.

17. An optical amplifier as recited in claim 16, further comprising an anti-reflective coating on said first surface of said second waveguide.

18. An optical amplifier as recited in claim 17, further comprising an anti-reflective coating on said second surface of said waveguide, and wherein said second surface defines an output facet through which the optical signal may exit said second waveguide.

19. An optical amplifier as recited in claim 17, further comprising a high reflective coating on said second surface of said waveguide, and wherein said first surface further defines an output facet through which the optical signal may exit said second waveguide.

20. An optical amplifier as recited in claim 16, wherein said waveguide, said second waveguide, and said substrate are constructed from group III and group V semiconductors.

21. A semiconductor optical switch constructed on a semiconductor substrate comprising:
an optical amplifier comprising first and second circular waveguides, each said waveguide having a first surface having an anti-reflective coating and defining a circular input facet through which an optical signal may enter each said waveguide, and a circular second surface generally parallel with said first surface, each said waveguide having a circular active region disposed between said first and said second surface; and
an optical power splitter optically coupled to said optical amplifier and having an input for receiving the optical signal and two outputs for directing the optical signal to said optical amplifier for amplification thereby and for output therefrom, said splitter splitting the optical signal received at said input equally between said two outputs, each one of said two outputs being optically coupled to a respective one of said waveguides of said optical amplifier.

22. An optical switch as recited in claim 21, wherein said second surface of each of said waveguides has an anti-reflective coating, and wherein said second surface defines an output facet through which the optical signal may exit each of said waveguides.

23. An optical switch as recited in claim 21, wherein said second surface of each of said waveguides has a high reflective coating, and wherein said first surface further defines an output facet through which the optical signal may exit each of said waveguides.

24. An optical switch as recited in claim 23, further comprising:
an optical isolator optically connected at each of said two outputs of said optical power splitter for preventing propagation of a light signal into each of said two outputs of said power splitter; and
an optical circulator optically connected to each optical isolator for permitting a light signal to pass through said optical circulator from an input to a first output when the light signal is propagating through said optical circulator in a first direction, and for permitting a light signal to pass through said optical circulator from said first output to a second output when a light signal is propagating through said optical circulator in a second direction, said second output of said optical isolator comprising an output of said optical switch.

25. An optical switch having M inputs and N outputs comprising:
a plurality of optically connected optical switches, each said switch comprising:
an optical amplifier comprising first and second circular waveguides each having an input and an output for providing two outputs of said optical switch, each said waveguide having a first surface having an anti-reflective coating and defining a circular input facet through which an optical signal may enter each said waveguide, and a second surface generally parallel with said first surface having an anti-reflective coating and defining a circular output facet through which an optical signal may exit each said waveguide, each said waveguide having a circular active region between said first and said second surface; and
an optical power splitter optically coupled to said optical amplifier and having an input for receiving the optical signal and providing an input of said optical switch and two outputs for directing the optical signal to said optical amplifier for amplification thereby and for output therefrom, said splitter splitting the optical signal received at said input equally between said two outputs, each one of said two outputs being optically coupled to one of said waveguide inputs of said optical amplifier.

26. An optical switch as recited in claim 25, wherein M equals 1.

27. An optical switch as recited in claim 25, wherein M is equal to N.

28. An optical switch matrix having M inputs and N outputs, said switch matrix comprising:
a plurality of optically connected guided wave optical switches, each said switch comprising:
an optical amplifier comprising first and second circular waveguides each having an input and an output for providing two outputs of said optical switch, each said waveguide having a first surface having an anti-reflective coating and defining a circular input facet through which an optical signal may enter each said waveguide, and a second surface generally parallel with said first surface having an anti-reflective coating and defining a circular output facet through which an optical signal may exit each said waveguide, each said waveguide having a circular active region between said first and said second surface; and
an optical power splitter optically coupled to said optical amplifier and having an input for receiving the optical signal and providing an input of said optical switch and two outputs for directing the optical signal to said optical amplifier for amplification thereby and for output therefrom, said splitter splitting the optical signal received at said input equally between said two outputs, each one of said two outputs being optically coupled to one of said waveguide inputs of said optical amplifier; and
a plurality of optical combiners, a first group of said plurality of optical combiners having a first input optically connected to one of the M inputs and a second input optically connected to receive an optical signal from one of said optical amplifiers, and a second group of said plurality of optical combiners having a first input optically connected to receive an optical signal from an output of one of said first group of optical combiners, and a second input optically connected to receive an optical signal from one of said optical amplifiers, said second group of optical combiners each having an output comprising one of the N outputs.

29. An optical system for receiving an optical signal from an optical signal source with a facet having a predetermined shape, said optical system comprising:
a semiconductor optical amplifier comprising a waveguide with a first surface defining an input facet through which the optical signal may enter from the optical signal source when proximate the optical signal source, said input facet having the same shape as the facet of the optical signal source, and a second surface generally parallel with said first surface, said waveguide having an active region disposed between said first surface and said second surface, said waveguide having the same shape as said input facet.
